(19) United States
(12) Patent Application Publication
(10) Pub. No.: US 2012/0107438 A1
(43) Pub. Date: May 3, 2012

(54) Device For Processing Powder For A Device For Manufacturing A Three-Dimensional Object And Device For Manufacturing A Three-Dimensional Object

(75) Inventors: Attila Bokodi, Ebersberg (DE); Thomas Reichel, Germering (DE)

(73) Assignee: EOS GMBH ELECTRO OPTICAL SYSTEMS, Krailling (DE)

(21) Appl. No.: 13/275,439

(22) Filed: Oct. 18, 2011

(30) Foreign Application Priority Data
Oct. 29, 2010 (DE) 10 2010 043 166.4

(51) Int. Cl. B29C 39/12; B01F 13/02; B01D 46/00; B29B 7/24

(52) U.S. Cl. 425/200; 425/447; 366/102; 55/385.1

(57) ABSTRACT

A device (1) for mixing powder (17) for a device for manufacturing a three-dimensional object comprises a stirring device (4) as well as a pressure-fluid-supply device for fluidizing the powder (17). A device (100) for manufacturing three-dimensional objects (503) is adapted to be connected to the device (100) for mixing powder (17) and it forms a system together with the device (1) for mixing powder (17).

The invention relates to a device for processing powder, in particular, to a device for mixing powder, which executes the mixing with a low use of energy and which is resource-efficiently constructed, for a device for manufacturing a three-dimensional object, in particular, for a laser sintering device. Further, the invention relates to a device for manufacturing a three-dimensional object.

Powder-based generative methods for manufacturing three-dimensional objects, such as for example, the selective laser sintering in which the three-dimensional object is generated in layers by solidification of a powdery material, are generally known. In the technique of the selective laser sintering, solidification occurs by means of a laser beam impinging on a powder layer. The powder which is not solidified is usually mixed with new powder and reused. In particular, in the case of the selective laser sintering, an arrangement in layers of the material from different sinter processes can happen in a used-powder container provided for used-powder when the used-powder is fed back into the material cycle. The different layers can have different powder characteristics which influence the sinter process and the quality of the component. Except that, depending on the powder in use, the characteristics of the used-powder are not identical to that of the new powder. For example, when using thermoplastic powders, thermal aging can happen. There are also applications for powder-based generative processes in which mixtures from different powder types differing in their chemical composition and/or their grain size are used.

In order to mix different powders, amongst others, two principles are generally known.

At fluidizing, compressed air is introduced from below into a container filled with a powder bulk. The introduction of the compressed air leads to a floating of the powder. In order to achieve mixing of the powder, a large amount of air is to be introduced with high pressure and, case-by-case, the amount of air being introduced in a pulsed flow. Here is the disadvantage that due to the introduction of air from below, an upside air flow substantially occurs and a transverse movement of the powder for a good mixing is missing. Furthermore, there is the risk that when mixing powders with different density, the lighter powder remains in the upper region of the powder bulk due to the strong air current and it is not mixed. The supply system for compressed air has to be designed such that a large amount of air is to be supplied with high pressure, requiring great dimensioning of the supply system with the corresponding production costs and operating costs and, in addition, it makes the purification of the out-going air expensive because large filter areas are necessary in order to purify the large air volume.

In the other principle, the powder bulk is mixed by means of a stirrer driven by a motor. The problem here is that the engine performance has to be high because the stirrer is to be started in a static bulk of the powder, requiring a very high starting torque. Thereby, the stirrer is exposed to high mechanical loads by the counterforce of the static bulk, leading to a need for the elements of the stirrer to be designed with mechanical toughness, on the one hand, in order to resist the occurring forces and, on the other hand, in order to provide wear resistance. For mixing the powder well, the rotational speed of the stirrer has to be high enough in order to swirl up the powder and to keep the entire powder bulk in movement. Thereby, additionally to the required construction for a high continuous power of the stirrer, there is the risk to damage the powder.

The object to provide a device for mixing powder, which is inexpensive in production and in operation and which, also, mixes different powders without the risk of damaging the powder underlies the present invention. Further, the object to provide a device for manufacturing three-dimensional objects, e.g. by laser sintering, which is suitable for cooperating with the device for mixing powder, whereby, due to the cooperation of the device for mixing powders and the device for manufacturing three-dimensional objects, the quality of the components as well as the efficiency of the manufacturing process shall be improved, is underlying.

The object is achieved by the features of claims 1, 19 and 20. Advantageous further developments are subject-matter of the dependent claims.

A device for mixing powder is designed such that it comprises a stirring device as well as a pressure fluid supply device. Further, a device for manufacturing three-dimensional objects is adapted to be connected to the device for mixing powder so that the device for mixing powder and the device for manufacturing three-dimensional objects form a system.

By equipping the device with a mixing device as well as with the pressure fluid supply device, the effect occurs that the device is more inexpensive in manufacturing costs as well as in operation costs than devices respectively comprising only one mechanism of action despite having two mechanisms of action, in particular, the stirring device and the pressure fluid supply device.

The advantage of costs in manufacturing arises due to the reason that the stirring device and a container can be designed with less structural reinforcement because the powder does not exist as a static bulk, quasi as a solid body, but it is already fluidized, that is, modified in a fluid-like state by the inflowing fluid when the stirring device is starting. Therefore, the drive motor of the stirring device does not need to be as powerful and also the requirements to the bearings and to the stirring tool in view of strength and stiffness are essentially lower so that a reduced input of material and the use of a less expensive material are possible.

In view of the pressure to be supplied and the volume flow of the fluid, the pressure fluid supply device can also be designed with less structural reinforcement because in a mixing device only operated with a fluid, the pressure and the volume flow of the inflowing fluid are essentially greater because the fluid must not only fluidize the powder but also must mix the powder, therefore, it must introduce a revolving movement into the powder. Further, elaborate control devices, e.g. for a pulsed inflow of the fluid, are not necessary. Furthermore, not only the feeding device of the fluid can be dimensioned smaller but also the devices for discharging and purifying the out-flowing fluid can be dimensioned smaller because, on the one hand, the fluid volume is smaller and, on the other hand, the pollution of the fluid by powder particles and dust whirled by the high pressure and the high volume flow is essentially less.

Due to the lighter construction of the drives and the functional assemblies, lower power consumption is necessary for operation so that the whole energy consumption is less than with single systems.

Further advantages of the combined construction of the device for mixing powder are that a very good mixing occurs in a very short time so that a high filling ratio of the device is possible because the device can be filled with powder up to 80% of its container volume, which, in turn, is beneficial for the use of energy. The mechanical stress of the powder or shear is low so that no grain alteration occurs and mixing of powders having components with different density is possible.

The fluidization and the stirrer support the discharge of the powder out of the device because the stirrer as well as the inflowing fluid keeps the powder in a moved fluid-like condition so that the powder can be discharged by the gravity. Also, by the inflowing fluid, a friction between the powder particles and the bottom in the bottom region is prevented so that a slight hopper shape is sufficient for discharging the device, which, in turn, enables a compact construction and which saves spatial resources.

In manufacturing, a simple scalability is possible and in operation, no moving parts are present outside the device, so that safety fencing can be abandoned. Also, special noise abatement measures are not necessary because the operation is very quiet.

By mixing the several powders very well, the problems that layers of different powders, either used-powder and new powder or powders having different grain sizes, are avoided when manufacturing three-dimensional bodies, e.g. laser-sintering. Thereby, the quality of the manufactured component is improved in view of the strength and the surface and the repeatability of the quality is increased. Besides that, for example when using thermoplastic powders, problems, when the mixing is bad, by thermal aging of the used-powder deposited in a layer-wise manner are avoided.

Further features and conveniences result from the description of an embodiment by means of the figures. The figures are showing:

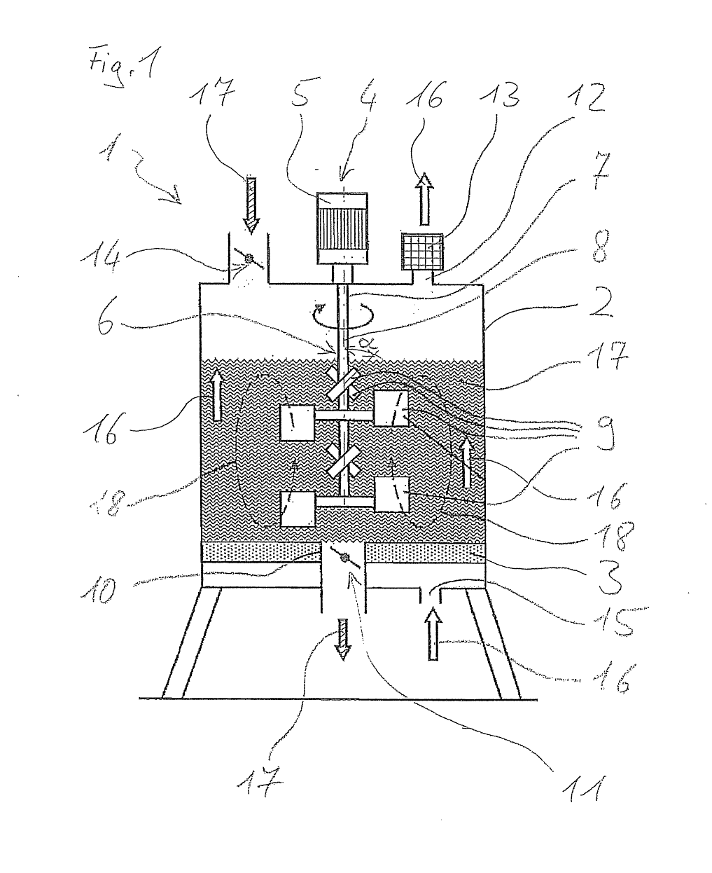

FIG. 1 an embodiment of the device according to the invention for mixing powder, and

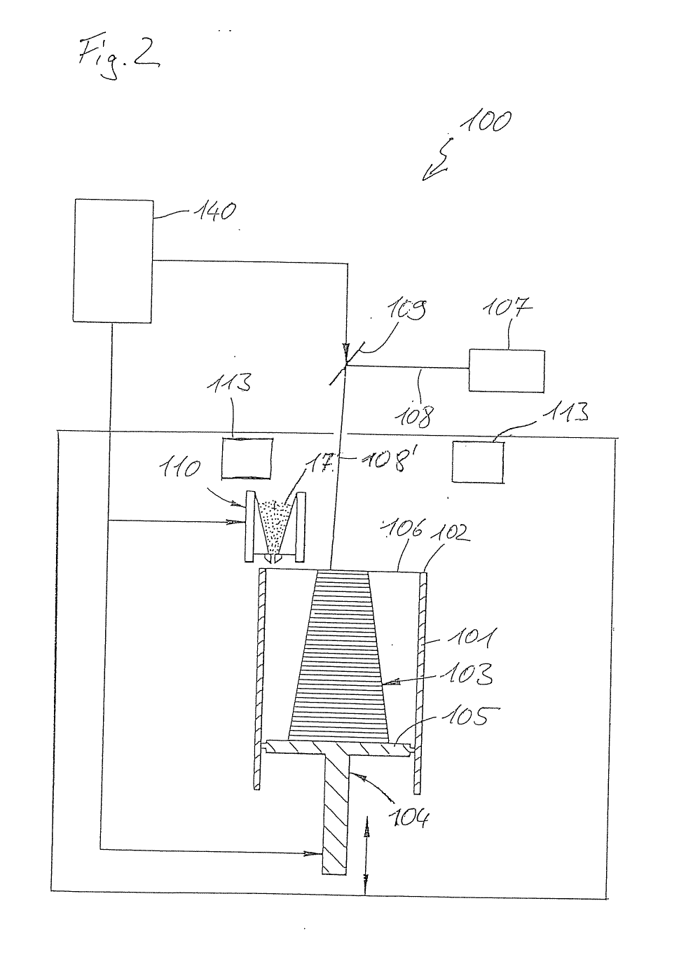

FIG. 2 a diagrammatic illustration of a laser sintering device as an embodiment of a device for manufacturing three-dimensional objects.

FIG. 1 shows a device 1 for mixing powders 17. The device 1 comprises a container 2 which in turn comprises a bottom. The container 2 is provided with a fluid permeable plate 3 in the area of its bottom. Further, the device 1 is provided with a stirring device 4. In the area of its bottom, the container 2 is provided with an inflow port 15 through which a fluid 16 can flow into the container 2. At the upper end, the container 2 comprises a lid provided with a powder inlet port 14 and a fluid outlet port 12 at which a filter member 13 is attached. Here, the bottom of the container 2 is provided with a closable outlet port 11 at its center. A container has a horizontal cross-section which is suitable for a good mixing of the powder. In this embodiment, the horizontal cross-section is circular, however, in other embodiments; it can be polygonal, oval, etc. Alternatively, the container 2 comprises a fluid-permeable bottom which is slightly hopper-shaped.

For example, the fluid-permeable plate 3 is manufactured from a porous material, e.g. a sintered plastic material, from a perforated plate or the like and it is permeable for the fluid 16. The plate 3 is formed such that it has an outside shape which is fitted in the inner cross-section of the container 2. In the center, the fluid-permeable plate 3 is provided with a port 10, aligned with the outlet port 11 in the bottom of the container and which has the same size. The upper face of the fluid-permeable plate 3 is constructed slightly hopper-shaped so that the powder 17 flows out of the container due to its gravity. Slightly hopper-shaped means that an angle formed by the upper face of the plate 3 and the horizontal is about 20°±10° in a vertical section. The effect resulting from that is described below when describing the operation of the device 1.

The stirring device 4 comprises the motor 5 and a stirring tool 6. The stirring device 4 is arranged in the center of the container 2.

The motor 5 is an electric motor which is dimensioned accordingly in order to rotate the stirring tool 6. The motor 5 is attached to the lid of the container 2 outside the container 2.

The stirring tool 6 comprises a shaft 7 which is rotatable about an axis 8. The axis 8 of the shaft 7 is arranged vertically.

To the shaft 7, paddles 9 are attached. The paddles 9 are respectively located radially beside the shaft 7. In this embodiment, the paddles 9 are arranged in four planes, whereby two paddles are always attached via fixing members in one plane. In alternative embodiments, one paddle 9 or several paddles 9 can be arranged in one plane. When arranging one paddle 9 in one plane, however, it should be noted that except a torsion force also a bending force is exerted onto the shaft 8. The paddles 9 and the axis 8 include an angle α, the amount of which is larger than 0° and smaller than 90° so that the paddles 9 are obliquely standing with respect to the axis 8. Here, the shape of the paddles 9 is rectangular, however, it can be also circular, oval, or in another suitable shape.

The inflow port 15 is connected to a pressure fluid supply device (not shown). The pressure fluid supply device is dimensioned such that it supplies compressed air as to be the fluid 16 in a sufficient amount with a sufficient pressure to the container 2. Instead of compressed air, another suitable gas can be used as a fluid 16. Between the inflow port 15 and the fluid-permeable plate 3, a chamber exists in the container, in which the fluid 16 can spread along the fluid-permeable plate 3 in order to evenly flow through the fluid-permeable plate 3.

The powder inlet port 14 in the lid of the container 2 is adapted such that the powder 17 can be inserted into the container 2 by the powder inlet port 14. The powder inlet port 14 is closable by a suitable shut-off device, and it is connected to a supply device (not shown) for one or several powders 17. In alternative embodiments, the powder inlet port 14 can also be provided at another location, e.g. at the side-wall above the filling level of the powder bulk.

The fluid outlet port 12 in the lid of the container 2 is adapted such that the fluid 16 flowed in the container can get away. The fluid outlet port 12 is either directly or via a tube line or hose line connected to the filter member 13. Instead of in the lid, the fluid outlet port 12 can be provided at another location, as e.g. at the sidewall. In an alternative embodiment, however, it is provided in the upper region of the container so that the fluid does not escape until it has floated through the powder. Further, alternatively, an embodiment without the filter member 13 is possible.

The closable outlet port 11 is adapted to let the mixed powder 17 out of the container 2. The outlet port 11 is provided with a suitable shut-off device which, in its closed state, safely closes the container and has low flow resistance for the out-flowing powder 17. The outlet port 11 is connected to a device for manufacturing three-dimensional objects. In alternative embodiments, the outlet port 11 can be connected to a filling device instead of the device for manufacturing the three-dimensional objects. Alternatively, the outlet port 11 can also be provided at another location in the bottom.

In an alternative embodiment, the axis 8 of the shaft 7 can also be oriented in another direction. Then, the horizontal section of the container 2 is correspondingly adapted.

The device 1 is dimensioned such that it can mix powders from different materials. The grain size of the powder 17 is between 50 μm and 150 μm. The device 1 is adapted such that pressure and volume flow of the inflowing fluid 16 and size, geometric conditions and rotational speed of the stirring device 4 are designed such that the powder 17 from determined materials are well-mixed with the corresponding grain sizes.

As seen in FIG. 2, the laser-sintering device 100, as to be an embodiment of a device for manufacturing three-dimensional objects, comprises a container or a building container 101 open to the top with an upper rim 102. The cross-section of the container 101 is larger than the largest cross-sectional area of an object 103 to be manufactured. In the container 101, a carrier 104 with a substantially even surface 105 facing the upper rim 102 is provided for carrying the object 103 to be formed. The carrier 104 is movable in an upward and downward manner in a vertical direction by means of a drive (schematically implied in FIG. 1) in the container 101. The upper rim 102 of the container 101 defines a working plane 106.

Above the working plane 106, a radiation device formed by a laser 107 emitting a directed light beam 108 is arranged. A deflection device 109, e.g. as a system of galvanometer mirrors, by means of which the light beam 108 as to be a deflected beam 108′ deflectable to each desired location of the working plane 106 is provided.

Further, a coater 110 for depositing a layer of a powder material 17 to be solidified on the carrier surface 105 or a recently solidified layer is provided. The coater 110 is movable back and forth by means of a drive (schematically implied) from a first end position at a side of the container 101 to a second end position at the opposite side of the container 101 above the working plane 106. For filling the coater 110, a filling container 113 for filling the coater 110 with powder material 17 is respectively provided above the end positions of the coater 110.

The filling container 13 is connected to the outlet port 11 of the device 1 provided as to be a separate device in this embodiment. In alternative embodiments, the device 1 is integrated in the device 100.

Furthermore, a control device 140 by which the drive for adjusting the position of the carrier 104, the drive for moving the coater 110 and the drive for adjusting the deflection device 109 are controllable in a coordinated manner or independently is provided. In embodiments in which the device 1 is integrated in the device 100, the operation of the device 1 can also be controllable by the control device 140.

In operation, the container 2 of the device 1 is filled with the desired powders 17 through the powder inlet port 14. Therefore, the shut-off device of the powder inlet port 14 is opened and the powders are inserted in the container 2 via the feeding device.

After the filling, compressed air 16 is blown through the inlet port into the space below the fluid-permeable plate 3, the compressed air spreads in the space and then flows evenly through the fluid-permeable plate 3. The powder 17 is fluidized, therefore, modified into a fluid-like condition, by the compressed air 16 flowing in a constant flow through the powder 17. Thereby, the movability of the powder is increased. The inserted compressed air escapes through the fluid outlet port 11 out of the container 2 after flowing through the powder 17 and, subsequently, it is purged from powder particles and other dust by means of the filter member 13.

After fluidizing of the powder, which is maintained during the whole mixing process, the stirrer is put into action. By the fluidizing of the powder 17, the resistance of the powder 17 against the movement of the paddles 9 is low so that the starting torque of the motor 5 can be small and the requirements to the mechanical strength of the stirring tool 6 are not high. By the movement of the paddles 9 and their oblique position with respect to the axis 8, the powder 17 is upwardly and laterally moved in the region of the stirring tool 6. In the region of the wall of the container 2, the powder 17 descends. Therefore, the powder flow 18 which, on the one hand, is formed as to be a radially circulating flow over the whole circumference and, on the other hand, comprises a tangential component which causes a gentle mixing process with minimum shear of the powder and a good mixing of the powder so that the mixing time is comparably short.

When the mixing process is terminated, the shut-off device of the closable outlet port 11 is opened and the powder 17 flows out of the container 2 by the gravity. During outflow of the powder 17, the stirring device 4 as well as the pressure fluid supply device is further operated so that the powder can flow out in a fluid-like form and so that a static bulk does not occur due to its gravity. By the inflowing compressed air 16, depositing of the powder 17 on the fluid-permeable plate 3 is prevented. Because, thereby, the friction force between the powder 17 and the upper surface of the plate 3 is reduced or abolished, the powder 17 flows out of the container 2 by its gravity even when the shape of the plate 3 is only slightly hopper-shaped, so that installation space which would be caused by an increased hopper shape can be saved.

The containers 113 are filled with the mixed powder 17 by conveying the powder 17 flowing out of the container 2 into the containers 113 by means of a conveying medium (not shown), e.g. compressed air, flowing in the connection line between the outlet port 11 and the containers 113.

The building process for manufacturing the three-dimensional bodies then takes place in a conventional manner.

The invention is not limited to laser-sintering, but it is also applicable in other powder based generative processes for manufacturing three-dimensional objects. A further example for such a process is the three-dimensional printing by which a powder layer is solidified by means of a bonding agent. A further example is mask sintering whereby, instead of a laser, an extending light source selectively exposing via a mask is used.

1. Device for mixing powder for a device for manufacturing a three-dimensional object, with
a container adapted to accommodate the powder wherein the container comprises a fluid-permeable lower plate,
a pressure fluid supply device connected to the container so that a fluid flows in through the fluid-permeable lower plate, the pressure fluid supply device is adapted such that the fluid inflowing through the fluid-permeable plate upwardly moves the powder,
characterized in that
the device comprises a stirring device adapted to move the powder.

2. Device according to claim 1, characterized in that the stirring device is adapted to move the powder in a horizontal direction.

3. Device according to claim 1, characterized in that the stirring device comprises a motor and a stirring tool having a shaft with an axis.

4. Device according to claim 3, characterized in that the stirring tool is provided transversely or particularly laterally to the axis of the shaft with several paddles.

5. Device according to claim 4, characterized in that the paddles are arranged axially to the shaft in several tiers.

6. Device according to claim 4, characterized in that the paddles and the axis of the shaft include an angle with respect to each other which is bigger than 0° and smaller than 90°.

7. Device according to claim 4, characterized in that the stirring device is adapted such that when rotating the shaft, the paddles upwardly and laterally move the powder in the region of the stirring tool.

8. Device according to claim 3, characterized in that the axis of the shaft is vertically arranged.

9. Device according to claim 1, characterized in that the stirring device is arranged in a horizontal plane in the center of the container.

10. Device according to claim 1, characterized in that the device is adapted such that the fluid flows in in a constant flow.

11. Device according to claim 1, characterized in that the fluid-permeable plate is provided with a port in its center.

12. Device according to claim 11, characterized in that the device, in the lower region, comprises a closable port aligned with the port in the fluid-permeable plate.

13. Device according to claim 1, characterized in that the fluid-permeable plate is hopper-shaped.

14. Device according to claim 13, characterized in that the fluid-permeable plate is slightly hopper-shaped.

15. Device according to claim 1, characterized in that the device comprises a fluid outlet port in the upper region.

16. Device according to claim 15, characterized in that the fluid-outlet port is provided with a filter member.

17. Device according to claim 1, characterized in that the device comprises a closable powder inlet port through which the container is filled.

18. Device according to claim 17, characterized in that the powder inlet port is preferably provided in the lid.

19. Device for manufacturing three-dimensional objects, with
a carrier on which the object is built,
a coater for depositing layers of a solidifiable powder material at the location in the respective layer according to the object,
a solidification apparatus for solidifying the powder material at the locations of the layer according to the object, characterized in that the device is adapted to be connected to the device according to claim 1.

20. A system comprising:
a device for mixing powder for a device for manufacturing a three-dimensional object; and
a device for manufacturing three-dimensional objects;
wherein the device for mixing powder comprises:
a container adapted to accommodate the powder wherein the container comprises a fluid-permeable lower plate,
a pressure fluid supply device connected to the container so that a fluid flows in through the fluid-permeable lower plate, the pressure fluid supply device is adapted such that the fluid inflowing through the fluid-permeable plate upwardly moves the powder,
characterized in that the device comprises a stirring device adapted to move the powder; and
wherein the device for manufacturing three-dimensional objects comprises:
a carrier on which the object is built,
a coater for depositing layers of a solidifiable powder material at the location in the respective layer according to the object,
a solidification apparatus for solidifying the powder material at the locations of the layer according to the object, characterized in that the device is adapted to be connected to the device for mixing powder.

21. System according to claim 20, characterized in that the device for mixing powder is arranged separately from the device for manufacturing three-dimensional objects.

22. System according to claim 20, characterized in that the device for mixing powder is integrated in the device for manufacturing three-dimensional objects.
